(19) United States
(12) Patent Application Publication
(10) Pub. No.: US 2007/0063533 A1
(43) Pub. Date: Mar. 22, 2007

(54) FOLDING TOP ASSEMBLY WITH ADJUSTABLE ROOF BOW

(75) Inventors: Frank Zehnder, Hemmingen (DE); Thomas Halbweiss, Remseck (DE)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Bietigheim-Bissingen (DE)

(21) Appl. No.: 11/533,137

(22) Filed: Sep. 19, 2006

(30) Foreign Application Priority Data
Sep. 19, 2005 (DE) 10 2005 044 742.2

(51) Int. Cl. B60J 7/12

(52) U.S. Cl. 296/118

(57) ABSTRACT

A motor vehicle folding top assembly includes a folding top movable between a closed position in which the folding top is extended along a longitudinal axis and a stored position in which the folding top is compressed. An arched roof bow is connected to the folding top and runs transversely to the longitudinal axis. An adjusting device is connected to the first roof bow and is pivotably connected to the folding top such that upon actuation, while the folding top moves between the closed and stored positions, the adjusting device pivots to move the roof bow and thereby change the degree or direction of arching of the roof bow such that the arching degree in the stored position is less than the arching degree in the closed position or the direction of arching in the stored position is different than the direction of arching in the closed position.

### CROSS-REFERENCE TO RELATED APPLICATIONS

This application claims foreign priority benefits under 35 U.S.C. § 119(a)-(d) to DE 10 2005 044 742.2, filed Sep. 19, 2005, which is hereby incorporated by reference in its entirety.

### BACKGROUND OF THE INVENTION

1. Field of the Invention

The present invention relates to a motor vehicle folding top movable between closed and stored positions and having an arched roof bow running transverse to the vehicle's longitudinal axis with the roof bow arranged in the area of the folding top adjacent to the vehicle body when the folding top is in the closed position such that the roof bow may lock to a windshield frame of the motor vehicle.

2. Background Art

DE 197 34 671 C2 (corresponds to U.S. Pat. No. 5,938,271) describes a folding top having a slightly arched and rigid roof bow. The roof bow may lock with the windshield frame of a vehicle body when the folding top is in its closed position. A problem is that the roof bow consumes a relatively large amount of storage space when the folding top is in its stored position.

EP 1 128 973 B1 (corresponds to U.S. Pat. No. 6,550,842) describes a folding top having a roof bow with three roof bow segments. The roof bow segments are adjacent to one another along the vehicle's transverse direction and are articulately connected with one another. In the folding top closed position, the roof bow is vertically arched with respect to the vehicle's longitudinal axis. In the folding top stored position, the middle roof bow segment comes to lie on the two outer roof bow segments. Although this reduces the amount of space required in the transverse direction, it increases the space required perpendicular to the transverse axis of the roof bow.

### SUMMARY OF THE INVENTION

An object of the present invention is a motor vehicle folding top having a roof bow in which the folding top is movable between a closed position covering the vehicle interior and a stored position within a storage area of the vehicle with the folding top consuming a relatively small amount of storage space while in the stored position.

In carrying out the above object and other objects, the present invention provides a folding top assembly for a motor vehicle. The folding top assembly includes a folding top movable between a closed position in which the folding top is extended along a longitudinal axis and a stored position in which the folding top is compressed. An arched roof bow is connected to the folding top and runs transversely to the longitudinal axis. The roof bow has first and second outer ends. An adjusting device is connected to the first roof bow end and is pivotably connected to the folding top such that upon actuation, while the folding top moves between the closed and stored positions, the adjusting device pivots to move the roof bow and thereby change the degree of arching of the roof bow such that the roof bow arching degree in the stored position is less than the roof bow arching degree in the closed position. Additionally or alternatively, the adjusting device is connected to the first roof bow end and is pivotably connected to the folding top such that upon actuation, while the folding top moves between the closed and stored positions, the adjusting device pivots to move the roof bow and thereby change the direction of arching of the roof bow such that the roof bow arching direction in the stored position is different than the roof bow arching direction in the closed position.

In carrying out the above object and other objects, the present invention provides another folding top assembly for a motor vehicle. This folding top assembly includes a folding top movable between a closed position in which the folding top is extended along a longitudinal axis and a stored position in which the folding top is compressed. A roof bow is connected to the folding top and runs transversely to the longitudinal axis. The roof bow has first and second outer ends. The roof bow has a middle section with an arch along a given direction. First and second longitudinal links are connected at opposite sides of the folding top. A first adjusting device has a first connecting link pivotably connected to the first roof bow end and pivotably connected to the first longitudinal link. A second adjusting device has a second connecting link pivotably connected to the second roof bow end and pivotably connected to the second longitudinal link. An actuator is coupled to the connecting links. The actuator actuates the connecting links causing the connecting links to pivot towards the respective longitudinal links thereby pivoting the roof bow outer ends in a direction toward the respective longitudinal link and in a direction opposite to the direction of the arch and moving the middle section of the roof bow in the direction opposite the direction of the arch such that the degree of arching of the middle section of the roof bow becomes smaller.

In an embodiment of the present invention, at least one adjusting device is used to change the degree of arching of the roof bow. In this embodiment, the degree of arching of the roof bow changes such that the degree of arching of the roof bow is smaller in the stored position than it is in the closed position. As such, the roof bow is flatter and requires less storage space in the stored position than in the closed position.

In an embodiment of the present invention, at least one adjusting device is used to change the direction of arching of the roof bow. In this embodiment, the arching direction of the roof bow is different in the closed position than in the stored position. The change in the arching direction of the roof bow changes its shape. This allows the roof bow to be adapted to the shape of the rest of the folding top in the stored position and/or to the shape of a storage compartment for the folding top. This results in saving space occupied by the entire folding top in the stored position.

In an embodiment of the present invention, both the arching degree and the arching direction of the roof bow are changed. For example, after the roof bow arching direction is changed, the roof bow arching degree is smaller than that when the roof bow is in the closed position. It is advantageous if at least one common adjusting device is used to adjust the arching degree/direction of the roof bow.

In an embodiment of the present invention, a folding top includes a plurality of roof bows. The roof bows are positioned along the vehicle's longitudinal direction when the folding top is in the closed position. Preferably, the roof bows are adjacent to one another. At least one of the roof bows may be locked to the vehicle body when the folding top is closed. The degree and/or direction of arching of each roof bow may be be changed individually. As a result, optimal adaptation to the storage position is possible thereby allowing a greater reduction in required storage space.

In an embodiment of the present invention, if the arching direction of the roof bow is changeable by an adjusting device, then the degree of arching of the roof bow in the changed arching direction is the same or greater in the stored position than in the closed position. This allows the shape of the roof bow to be adapted to the storage situation of the rest of the folding top or to the shape of a storage compartment for the folding top.

For many applications, it is sufficient if the arching direction of the roof bow in the stored position is substantially or exactly opposite that of the roof bow in the closed position.

In an embodiment of the present invention, each outer end of a roof bow has an associated locking device. If a plurality of roof bows are arranged next to one another in the vehicle's longitudinal direction, it is advantageous if at least two, and preferably all, roof bows on a common outer side can be adjusted by a common adjusting device. It is advantageous if a common adjusting device is provided for at least two roof bows on at least one outer side.

In an embodiment of the present invention, the degree and/or direction of arching is changed by a transverse movement of the roof bow produced by the adjusting device. Because the roof bow on at least one outer end can move transverse to the vehicle's longitudinal axis, the middle area of the roof bow can move perpendicular to the transverse axis of the roof bow. It is advantageous if both outer ends of the roof bow each have a respective adjusting device such that the outer ends of the roof bow can move in an opposite direction transverse to the vehicle's longitudinal axis. The adjusting device during its adjustment movement may initially move at least one outer end of the roof bow in the direction of the vehicle's outer side. This may be done, for example, to initially reduce the degree of arching until the arching direction changes. Subsequently, another movement of the outer end of the roof bow is then made transverse to the vehicle's longitudinal axis in the direction of the middle of the vehicle in order to increase the degree of arching in the other (opposite) arching direction to adapt the shape of the roof bow to the stored folding top and/or to a storage compartment for the folding top.

It is also advantageous if the adjusting device can move at least one outer end of the roof bow perpendicular to the transverse axis of the roof bow. This allows the position of the roof bow adapt to conditions in the stored position. The outer end can also be conveyed by the perpendicular movement into an area in which sufficient space is available for a subsequent or simultaneous transverse movement.

In an embodiment of the present invention, each adjusting device includes a connecting link. The connecting link pivots with at least one first joint on an outer end area of the roof bow, and with at least one second joint on a longitudinal link of the folding top on the side of the roof bow. This allows the roof bow to pivot relative to the longitudinal link. The adjusting device includes an actuator to bring about the pivoting movement. The rotation movement about the first joint moves the outer end both perpendicular to the transverse axis and also in the transverse direction. Preferably, each outer end of the roof bow is associated with a connecting link and an adjusting device. As indicated, it is possible for a plurality of roof bows on a common side to be adjusted by a common adjusting device.

In an embodiment of the present invention, the actuator is articulately connected with the connecting link. Here it is advantageous if the point of application of the actuator on the connecting link is guided in a guide slot of the connecting link. This can keep the height offset of the actuator to the second joint constant during the adjustment movement.

To achieve a constant height offset of the actuator to the second joint, it is advantageous if the guide slot is in the form of an elongated hole running in the direction of the second joint. During the pivoting movement, the point of application of the actuator on the connecting link, for example a pin guided in the guide slot, then travels along the elongated hole. This does not require the actuator to move on a radius. As such, the actuator can execute a purely translational movement.

For space reasons it is advantageous if the actuation is applied to the connecting link from the outside of the vehicle, preferably making a translational movement transverse to the vehicle's longitudinal axis.

The actuator may be a push/pull cable which can have tensile and compressive force applied to it.

In an embodiment of the present invention, the actuator includes a cable guided through an eye connected with the roof bow. It is advantageous for the eye to be fastened to the roof bow in the area of the roof bow that is in the middle in the transverse direction or to part of it. Depending on the tension of the cable, the roof bow (i.e., the middle area of the roof bow) moves perpendicular to the transverse axis of the roof bow. If, for example, the roof bow is strongly arched when the cable is completely taut, then the arch will become flatter when the cable tension is relaxed.

In order to make the roof bow move perpendicular to the transverse axis of the roof bow when there is a change in the cable tension, it is advantageous for the cable, on at least one side of the eye, not to run parallel to the transverse axis of the roof bow. It is advantageous for the angle between the cable and the transverse axis of the roof bow to be at least 10°.

In order to make it easier to change the degree and/or the direction of arching of the roof bow using at least one adjusting device, it is advantageous for the roof bow to have, in the transverse direction, a plurality of segments preferably two) articulately connected with one another by least one connection joint. When at least one outer side of the roof bow moves, the segments pivot about the connection joint towards one another.

In an embodiment of the present invention, to allow a plurality of roof bows that are adjacent in the longitudinal direction to be adjusted together by a single adjusting device, at least some of the segments of the roof bows are rigidly connected with one another in the longitudinal direction. This makes the adjustment of one roof bow act on the rest of the roof bows. Thus, the movement of the roof bows is synchronized.

It is advantageous for a roof bow to have only two segments that can pivot with the two segments being symmetric. In this case, the common connection joint is arranged in the middle between the two outer sides of the folding top.

In an embodiment of the present invention, at least one of the segments is rigid. When connection joints are used, it is advantageous for all segments to be rigid to ensure the necessary strength of the roof bow.

In an embodiment of the present invention, to realize the movement of the roof bow perpendicular to its transverse axis, in the closed position the first joint or the second joint and/or the connection joint runs approximately parallel to the vehicle's longitudinal axis. It is advantageous for these joints to run parallel to the vehicle's longitudinal axis such that when viewed in closed position the roof bows pivot upward or downward.

To allow the roof bow to assume different shapes in the closed position and in the stored position, it is advantageous for at least one segment of the roof bow to include an elastic material.

In an embodiment of the present invention, the roof bow is made as a single piece out of an elastic material. In this case, it is possible to do without intermediate joints. If the entire roof bow is made out of an elastic material, it is necessary to see to it that it is sufficiently strong. In the closed position, the strength of the roof bow can be ensured by laying the roof bow on supports on the vehicle body.

The above features, and other features and advantages of the present invention are readily apparent from the following detailed descriptions thereof when taken in connection with the accompanying drawings.

### BRIEF DESCRIPTION OF THE DRAWINGS

FIG. 1 illustrates a perspective view of a folding top having a roof bow in which the folding top is movable between a closed position as shown in FIG. 1 and a stored position in accordance with an embodiment of the present invention;

FIG. 2 illustrates a front view of the roof bow in the closed position;

FIG. 3 illustrates a front view of the roof bow in the stored position;

FIG. 4 illustrates an enlarged view of an adjusting device of the roof bow in the closed position;

FIG. 5 illustrates an enlarged view of the adjusting device of the roof bow in the stored position;

FIG. 6 illustrates a perspective view of three roof bows of the folding top in the closed position;

FIG. 7 illustrates a perspective view of the roof bows in the stored position;

FIG. 8 illustrates a rear view of the roof bows in the closed position;

FIG. 9 illustrates a rear view of the roof bows in the stored position;

FIG. 10 illustrates a side view of a roof bow in the closed position; and

FIG. 11 illustrates a side view of a roof bow in the stored position.

### DETAILED DESCRIPTION OF THE PREFERRED EMBODIMENT(S)

In the figures, components that are the same and components that have the same function are labeled with the same reference numbers.

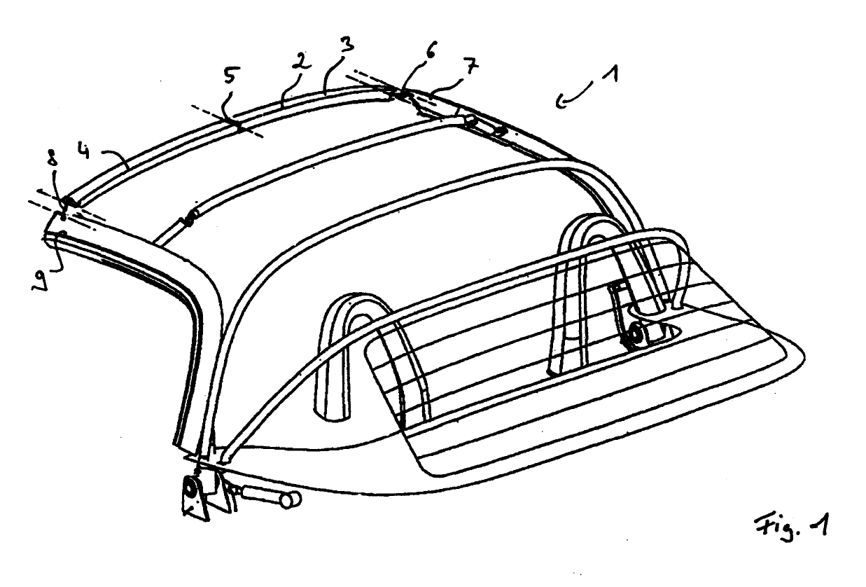

Referring now to FIG. 1, a perspective view of a folding top 1 in accordance with an embodiment of the present invention is shown. Folding top 1 is for use with a motor vehicle. Folding top 1 is movable between a closed position in which the folding top covers the vehicle interior and a stored (stowed or opened) position in which the folding top is stored in a storage area of the vehicle thereby exposing the vehicle interior. As such, folding top 1 is extended in the closed position and is compressed together in the stored position.

Folding top 1 includes at least one slightly arched roof bow such as roof bow 2. Each roof bow runs transversely to the vehicle's longitudinal axis. As shown in FIG. 1, roof bow 2 is arranged in the front area of folding top 1. Alternatively, roof bow 2 may be arranged in the middle or rear areas of the folding top as well.

Referring now to FIGS. 2 and 3, with continual reference to FIG. 1, roof bow 2 includes a first segment 3 and a second segment 4. Segments 3, 4 are rigid and symmetric with one another. Segments 3, 4 are adjacent to one another in the transverse direction (i.e., in the direction transverse to the vehicle's longitudinal axis). First segment 3 includes an inner end and an outer end 10. Likewise, second segment 4 includes an inner end and an outer end 11. Segments 3, 4 are articulately connected with one another at their inner ends by a connection joint 5 located in the transverse middle section of folding top 1.

On one side of folding top 1, outer end 10 of first segment 3 is articulately connected by a first connecting link 6 to a first longitudinal link 7 of folding top 1. On the opposite side of folding top 1, outer end 11 of second segment 4 is articulately connected by a second connecting link 8 to a second longitudinal link 9 of folding top 1. First and second longitudinal links 7, 9 run parallel to one another and along the vehicle's longitudinal axis. By virtue of being on opposite sides of folding top 1, longitudinal links 7, 9 are laterally spaced apart from one another. The pivot axes of connecting links 6, 8 and the pivot axis of connection joint 5 run substantially parallel to the vehicle's longitudinal axis. Both of connecting links 6, 8 have flat, triangular shapes.

FIG. 2 illustrates a front view of roof bow 2 in the closed position of folding top 1. In the closed position, roof bow 2 has a higher elevation in the area of connection joint 5 than the elevation at outer ends 10, 11 of the roof bow. As such, roof bow 2 is arched in the closed position of folding top 1. Arrow 12 indicates the direction of the arching. The arching enables roof bow 2 to adapt to the shape of a windshield frame of the motor vehicle body. As such, when positioned in the front area of folding top 1, roof bow 2 may be sealed and locked to the windshield frame.

FIG. 3 illustrates a front view of roof bow 2 in the stored position of folding top 1. Roof bow 2 has a lower elevation in the area of connection joint 5 in the stored position (shown in FIG. 3) than in the closed position (shown in FIG. 2). This gives roof bow 2 an overall flatter shape such that folding top 1 with roof bow requires relatively less storage space in the stored position.

Compared to the closed position, segments 3, 4 have pivoted about common connection joint 5 in the stored position. Particularly, first segment 3 has pivoted clockwise and second segment 4 has pivoted counter-clockwise. Further, in the stored position, outer ends 10, 11 have been lowered relative to longitudinal links 7, 9. Particularly, outer end 10 of first segment 3 has been moved transverse to the vehicle's longitudinal axis in the direction of first longitudinal link 7. In an analogous manner, outer end 11 of second segment 4 has been moved transverse to the vehicle's longitudinal axis in the direction of second longitudinal link 9.

The pivoting of first segment 3 is made through a first adjusting device 13 which includes first connecting link 6. The pivoting of second segment 4 is made through a second adjusting device 14 which includes second connecting link 8.

Roof bow 2 and adjusting devices 13, 14 are configured and operational with one another such that in the stored position the roof bow is not only flat, but its arching direction changes from pointing upward along direction 12 in the closed position to point downward.

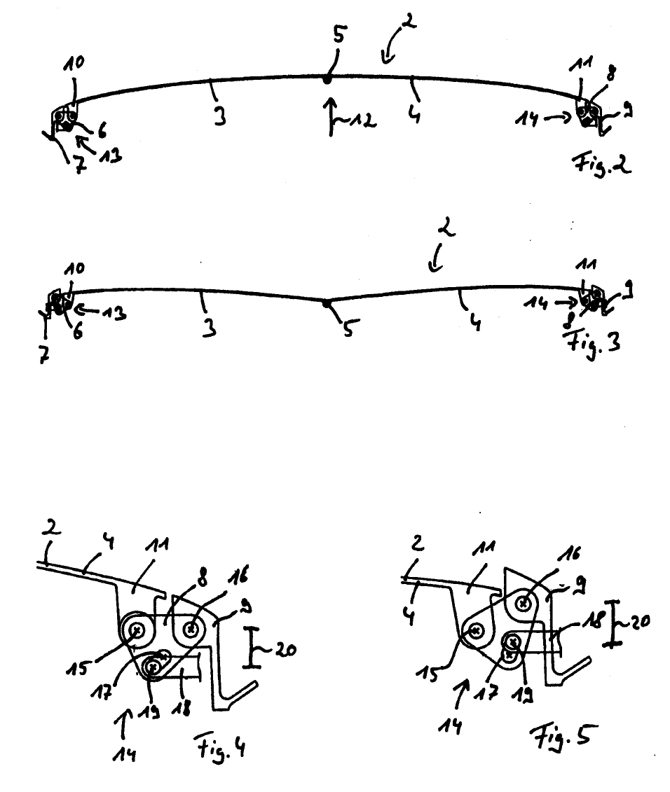

Referring now to FIGS. 4 and 5, with continual reference to FIGS. 1, 2, and 3, enlarged views of the connection of outer end 11 of second segment 4 to second longitudinal link 9 via second adjusting device 14 are shown. FIG. 4 illustrates second adjusting link 14 in the closed position. FIG. 5 illustrates second adjusting link 14 in the stored position. The operation of adjusting devices 13, 14 is essentially the same. As such, the operation of second adjusting device 14 will be described in greater detail with reference to FIGS. 4 and 5.

Second connecting link 8 of second adjusting device 14 pivots with a first joint 15 on outer end 11 of second segment 4. A second joint 16 on second longitudinal link 9 is separated from first joint. Second connecting link 8 pivots with second joint 16 on second longitudinal link 9. As shown in FIG. 4, in the closed position, first and second joints 15, 16 lie in the same horizontal plane. Second connecting link 8 has a guide slot 17. Guide slot 17 lies below joints 15, 16 and is in the form of an elongated hole. An actuator 18 has a pin 19 coupled to guide slot 17. Actuator 18 is in the form of a push/pull cable and pin 19 is guided within guide slot 17. Guide slot 17 runs at an angle from the bottom in the direction of the pivot axis of second joint 16. This maintains a constant height offset 20 between second joint 16 and pin 19 in the closed position, in the stored position, and during adjusting movement of folding top 1 between the closed and stored positions.

As noted, the degree of arching of roof bow 2 in the stored position is reduced (see FIG. 3) with respect to the degree of arching of the roof bow in the closed position (see FIG. 2). In order to move from the closed position to the stored position, push/pull cable 18 exerts a tensile force on second connecting link 8 through pin 19 in guide slot 17. This force causes second connecting link 8 to pivot counter-clockwise about second joint 16. In response, guide slot 17 travels along pin 19 such that pin 19 comes to lie in the upper end of guide slot 17 in the stored position. The pivoting movement makes first joint 15 with second connecting link also pivot counter-clockwise about second joint 16. In response, outer end 11 of second segment 4 travels downward, perpendicular to the transverse axis of roof bow 2 and travels transverse to the vehicle's longitudinal axis in the direction of second longitudinal link 9. As shown in FIG. 5, in the stored position, outer end 11 of second segment 4 is lowered with respect to second longitudinal link 9 and is brought more tightly against it. The net result is that this causes first and second segments to pivot about common connection joint 5 thereby reducing the degree of arching of roof bow 2.

In order to move from the stored position back to the closed position, push/pull cable 18 exerts a compressive force on second connecting link 8 through pin 19 in guide slot 17. This cause outer end 11 of second segment 4 to pivot clockwise about second joint 16 back to the closed position. The movement and pivoting of the components when moving from the closed position to the stored position as described above are reversed when moving from the stored position to the closed position. Further, as indicated above, the operation of first adjusting device 13 is the same as second adjusting device 14. However, the movement and pivoting of the components associated with second adjusting device 14 as described above is opposite to the movement and pivoting of the components associated with first adjusting device 13.

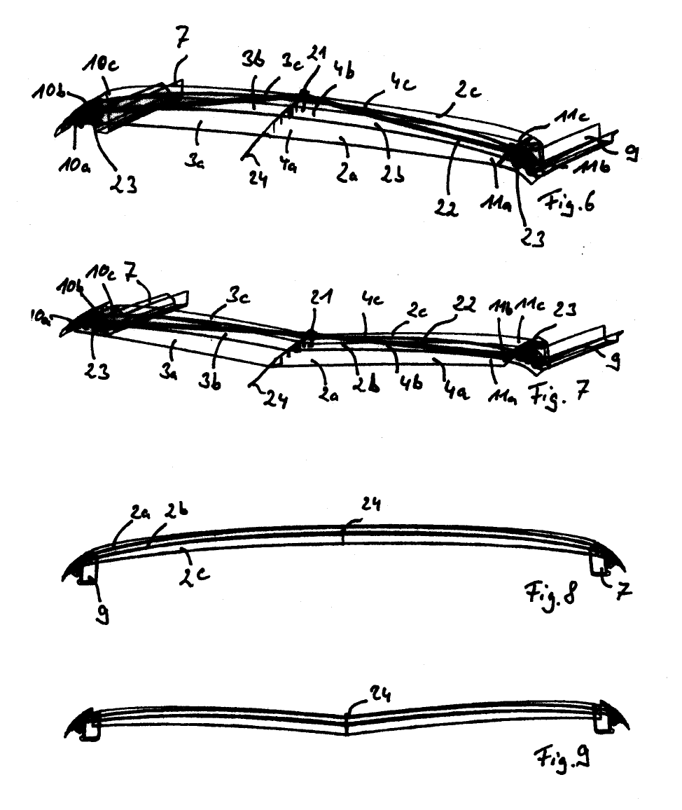

Referring now to FIGS. 6 and 7, with continual reference to the preceding figures, three roof bows 2a, 2b, 2c of folding top 1 in accordance with an embodiment of the present invention are shown. FIG. 6 illustrates the closed position and FIG. 7 illustrates the stored position.

Roof bows 2a, 2b, 2c are spaced apart from one another along the longitudinal direction of folding top 1. Roof bows 2a, 2b, 2c include front roof bow 2a, middle roof bow 2b, and rear roof bow 2c. Each roof bow 2a, 2b, 2c is generally similar to roof bow 2 described above. Front roof bow 2a includes two pivotable segments 3a, 4a; center roof bow 2b includes two pivotable segments 3b, 4b; and rear roof bow 2c includes two pivotable segments 3c, 4c. Roof segments 3a, 4a include respective outer ends 10a, 11a; roof segments 3b, 4b include respective outer ends 10b, 11b; and roof segments 3c, 4c include respective outer ends 10c, 11c. The outer ends of the segments of each roof bow are respectively articulately connected with first and second longitudinal links 7, 9. The inner ends of the segments of each roof bow are articulately connected together at a common pivot axis 24. The longitudinally adjacent segments are rigidly connected with one another.

An eye 21 is fastened to segment 4b of middle roof bow 2b as shown in FIGS. 6 and 7. Eye 21 is arranged perpendicular to middle roof bow 2b and is separated from the middle roof bow. A cable 22 passes through eye 21. Cable 22 extends through eye 21 toward each of first and second longitudinal links 7, 9. Cable 22 extends from eye 21 toward longitudinal links 7, 9 at an angle directed toward front roof bow 2a. A pair of eyes 23 are respectively associated with longitudinal links. Cable 22 passes through eyes 23 to an actuator (not shown). Through eye 21, a tensile stress is transferred from cable 22 to segment 4b of middle roof bow 2b. The rigid connection of the segments to one another transfers the tensile force to all of the segments. In the closed position (shown in FIG. 6), the actuator applies maximum tension to cable 22 such that the cable raises roof bows 2a, 2b, 2c thereby producing an arch.

As shown in FIG. 7, in the stored position, cable 22 is under less tension. This causes the transversely adjacent segments 3a, 4a; 3b, 4b; 3c, 4c; of roof bows 2a, 2b, 2c to pivot about common pivot axis 24. The articulated connection to first and second longitudinal links 7, 9 causes each of outer ends 10a, 10b, 10c, 11a, 11b, 11c of the segments to pivot outward as well, perpendicular to the transverse axis of the roof bows and transverse to the vehicle's longitudinal axis. The arching direction of roof bows 2a, 2b, 2c in the stored position (see FIG. 7) is opposite the arching direction of roof bows 2a, 2b, 2c in the closed position (see FIG. 6).

FIG. 8 illustrates a rear view of roof bows 2a, 2b, 2c arranged behind one another in the longitudinal direction in the closed position. The illustration of FIG. 8 omits eye 21, cable 22, and eyes 23 of the actuator assembly. The arch of roof bows 2a, 2b, 2c is apparent in FIG. 8.

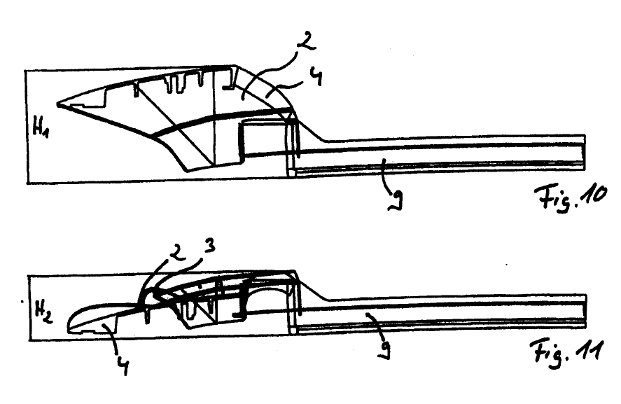

FIG. 9 illustrates a rear view of roof bows 2a, 2b, 2c arranged behind one another in the longitudinal direction in the stored position. The lowering of roof bows 2a, 2b, 2c in the area of common pivot axis 24 is apparent in FIG. 9.

FIG. 10 illustrates a side view of a roof bow 2 in the closed position and FIG. 11 illustrates a side view of the roof bow in the stored position. The raised position of second segment 4 of roof bow 2 is apparent in FIG. 10. In the closed position (FIG. 10), roof bow 2 including second longitudinal link 9 has a height of H1. In the stored position (FIG. 11), second segment 4 is lower than it is in the closed position. In the stored position, roof bow 2 including second longitudinal link 9 has a height of H2. Direct comparison of FIGS. 10 and 11 shows height H2 (in the stored position) is substantially less than height H1 (in the closed position).

List of Reference Numbers

1 Folding top

2 Roof bow

2a Front roof bow

2b Middle roof bow

2c Rear roof bow

3 First segment

3a, 3b, 3c First front, middle, rear segment

4 Second segment

4a, 4b, 4c Second front, middle, rear segment

5 Connection joint

6 First connecting link

7 First longitudinal link

8 Second connecting link

9 Second longitudinal link

10 Outer end

10a, 10b, 10c Outer end

11 Outer end

11a, 11b, 11c Outer end

12 Arching Arrow

13 First adjusting device

14 Second adjusting device

15 First joint

16 Second joint

17 Guide slot

18 Actuator

19 Pin

20 Height offset

21 Eye

22 Cable

23 Eyes

24 Common pivot axis

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A folding top assembly for a motor vehicle, the folding top assembly comprising:
a folding top movable between a closed position in which the folding top is extended along a longitudinal axis and a stored position in which the folding top is compressed;
an arched roof bow connected to the folding top and running transversely to the longitudinal axis, the roof bow having first and second outer ends; and
a first adjusting device connected to the first roof bow end and pivotably connected to the folding top such that upon actuation, while the folding top moves between the closed and stored positions, the adjusting device pivots to move the roof bow and thereby change the degree of arching of the roof bow such that the roof bow arching degree in the stored position is less than the roof bow arching degree in the closed position.

2. The folding top assembly of claim 1 further comprising:
a second arched roof bow connected to the folding top and running transversely to the longitudinal axis;
wherein one of the roof bows is arranged to be adjacent to a windshield frame of the motor vehicle when the folding top is in the closed position such that the one of the roof bows may be locked to the windshield frame.

3. The folding top assembly of claim 1 further comprising:
a second adjusting device connected to the second end of the roof bow and pivotably connected to the folding top such that upon actuation the adjusting devices pivot to move the roof bow and thereby change the roof bow arching degree.

4. The folding top assembly of claim 1 wherein:
the adjusting device pivots to move the first end of the roof bow transversely to the longitudinal axis.

5. The folding top assembly of claim 1 wherein:
the adjusting device pivots to move the first end of the roof bow perpendicular to the transverse axis of the roof bow.

6. The folding top assembly of claim 1 further comprising:
an actuator; and
a second adjusting device having a second connecting link;
wherein the folding top includes first and second longitudinal links on opposite sides of the folding top;
wherein the first adjusting device includes a first connecting link which is pivotably connected to the first roof bow end at a first joint and is pivotably connected to the first longitudinal link at a second joint;
wherein the second connecting link is pivotably connected to the second roof bow end at a second joint and is pivotably connected to the second longitudinal link at a second joint;
wherein the connecting links pivot with the joints to pivot the outer ends of the roof bow relative to the longitudinal links upon actuation of the connecting links by the actuator.

7. The folding top assembly of claim 6 wherein:
the actuator is articulately connected with the connecting links.

8. The folding top assembly of claim 7 wherein:
each connecting link includes a guide slot and the actuator includes respective pins are guided in the guide slots;
wherein the actuator actuates the connecting links by applying forces on the pins causing the connecting links to pivot with the pins moving along the guide slots.

9. The folding top assembly of claim 8 wherein:
the guide slot of a connecting link is an elongated hole running in the direction of the second joint of the connecting link.

10. The folding top assembly of claim 6 wherein:
the actuator applies onto the connecting links forces running transverse to the longitudinal axis to actuate the connecting links.

11. The folding top assembly of claim 10 wherein:
the actuator includes a cable which can apply tensile and compressive force to at least one of the connecting links.

12. The folding top assembly of claim 6 wherein:
the actuator includes a cable which passes through an eye connected to the roof bow, wherein the roof bow arching degree depends on the tension of the cable.

13. The folding top assembly of claim 12 wherein:
the cable runs at an angle from the eye towards the first and second outer ends of the roof bow.

14. The folding top assembly of claim 1 wherein:
the roof bow has includes first and second roof bow segments, the first roof bow segment having a first inner end and the first outer end, the second roof bow segment having a second inner end and the second outer end;
wherein the inner ends of the roof bow segments are articulately connected with one another by at least one connection joint.

15. The folding top assembly of claim 14 further comprising:
a second arched roof bow connected to the folding top and running transversely to the longitudinal axis, the second roof bow having first and second roof bow segments;
wherein at least some of the segments of the roof bows are rigidly connected with one another in the longitudinal direction.

16. The folding top assembly of claim 14 wherein:
the first and second roof bow segments are symmetric.

17. The folding top assembly of claim 14 wherein:
at least one of the roof bow segments is rigid.

18. The folding top assembly of claim 14 wherein:
at least one of the roof bow segments includes an elastic material.

19. The folding top assembly of claim 1 wherein:
the roof bow is a single piece of elastic material.

20. The folding top assembly of claim 6 wherein:
at least one of the first and second joints run substantially parallel to the longitudinal axis.

21. A folding top assembly for a motor vehicle, the folding top assembly comprising:
a folding top movable between a closed position in which the folding top is extended along a longitudinal axis and a stored position in which the folding top is compressed;
an arched roof bow connected to the folding top and running transversely to the longitudinal axis, the roof bow having first and second outer ends; and
an adjusting device connected to the first roof bow end and pivotably connected to the folding top such that upon actuation, while the folding top moves between the closed and stored positions, the adjusting device pivots to move the roof bow and thereby change the direction of arching of the roof bow such that the roof bow arching direction in the stored position is different than the roof bow arching direction in the closed position.

22. The folding top assembly of claim 21 wherein:
the arching degree of the roof bow in the stored position is at least the same as the arching degree of the roof bow in the closed position.

23. The folding top assembly of claim 21 wherein:
the roof bowl arching direction in the stored position is opposite the roof bow arching direction in the closed position.

24. A folding top assembly for a motor vehicle, the folding top assembly comprising:
a folding top movable between a closed position in which the folding top is extended along a longitudinal axis and a stored position in which the folding top is compressed;
a roof bow connected to the folding top and running transversely to the longitudinal axis, the roof bow having first and second outer ends, the roof bow having a middle section with an arch along a given direction;
first and second longitudinal links connected at opposite sides of the folding top;
a first adjusting device having a first connecting link, the first connecting link pivotably connected to the first roof bow end and pivotably connected to the first longitudinal link;
a second adjusting device having a second connecting link, the second connecting link pivotably connected to the second roof bow end and pivotably connected to the second longitudinal link; and
an actuator coupled to the connecting links;
wherein the actuator actuates the connecting links causing the connecting links to pivot towards the respective longitudinal links thereby pivoting the roof bow outer ends in a direction toward the respective longitudinal link and in a direction opposite to the direction of the arch and moving the middle section of the roof bow in the direction opposite the direction of the arch such that the degree of arching of the middle section of the roof bow becomes smaller.
